(19) United States
(12) Patent Application Publication
(10) Pub. No.: US 2012/0006925 A1
(43) Pub. Date: Jan. 12, 2012

(54) High Seal Retractor Pretensioner Piston

(76) Inventors: Jon Burrow, Ortonville, MI (US); Gerald Keller, Sheiby Township, MI (US)

(21) Appl. No.: 12/830,792

(22) Filed: Jul. 6, 2010

(51) Int. Cl. B60R 22/46

(52) U.S. Cl. 242/374

(57) ABSTRACT

A pretensioner assembly for motor vehicle belt restraint systems is provided. The pretensioner assembly includes a tube in fluid communication with a gas generator. An elastic piston disposed within the tube is operable to drive a plurality of balls upon receiving pressurized gas discharged from the gas generator. The piston includes a proximate end and a distal end. The proximate end includes a flexible rim that expands upon receiving pressurized gas from the gas generator, and the distal end includes a flexible rim that expands in response to backpressure from the plurality of balls. The expansion of the flexible rims at the proximate and distal ends of the piston provides a tight seal between the piston and the inner peripheral wall of the tube.

### FIELD OF THE INVENTION

The present invention relates generally to seatbelt restraint devices for restraining an occupant of a vehicle, and more particularly, to devices for pretensioning a seatbelt.

### BACKGROUND OF THE INVENTION

Seatbelt restraint systems for restraining an occupant in a vehicle seat play an important role in reducing occupant injury in vehicle crash situations. Seatbelt restraint systems of the conventional so-called “3-point” variety commonly have a lap belt section extending across the seat occupant's pelvis and a shoulder belt section crossing the upper torso, which are fastened together or are formed by a continuous length of seatbelt webbing. The lap and shoulder belt sections are connected to the vehicle structure by anchorages. A belt retractor is typically provided to store belt webbing and may further act to manage belt tension loads in a crash situation. Seatbelt restraint systems which are manually deployed by the occupant (so-called “active” types) also typically include a buckle attached to the vehicle body structure by an anchorage. A latch plate attached to the belt webbing is received by the buckle to allow the belt system to be fastened for enabling restraint, and unfastened to allow entrance and egress from the vehicle. Seatbelt systems, when deployed, effectively restrain the occupant during a collision.

OEM vehicle manufacturers often provide seatbelt restraint systems with pretensioning devices, which tension the seatbelt either prior to impact of the vehicle (also known as a “pre-pretensioner”) or at an early stage of a sensed impact to enhance occupant restraint performance. The pretensioner takes out slack in the webbing and permits the belt restraint system to couple with the occupant early in the crash sequence. One type of pretensioner acts on the webbing retractor to tension the belt. Various designs of retractor pretensioners presently exist, including a type known as a roto-pretensioner that incorporates a gas generator for generating a pyrotechnic charge. Examples of such roto-pretensioners are described in U.S. Pat. No. 5,881,962 and U.S. patent application Ser. No. 11/115,583, which are commonly owned by the assignee of the present application and are hereby incorporated by reference in their entirety for all purposes. Generally, ignition of the pyrotechnic charge or other combustible material creates gas pressure in a chamber having a piston to impart motion upon a driving element such as a piston, rack, or series of balls disposed in a pretensioner tube, which engage with and wind a retractor spool sprocket to retract the webbing.

One issue with pretensioners utilizing gas generators is efficient utilization of the gas volume produced by the generator. For instance, a significant volume of the gas produced by the gas generator can leak through the pretensioner tube or around the piston or balls, thereby decreasing the pressure and force available for pretensioning the seat belt. Therefore, manufacturers use gas generators having sufficient output to compensate for gas leakages.

### BRIEF SUMMARY OF THE INVENTION

The present invention provides a pretensioner assembly that substantially reduces gas leakages within a pretensioner tube. The pretensioner assembly includes a pretensioner tube in communication with a gas generator. A driving element in the form of a piston having a generally cylindrical outer surface is disposed within the tube. The piston is operable to impart motion onto driving a element such as a plurality of balls loaded in the tube (or a “ball string”) in reaction to pressurized gas discharged from the gas generator. The piston includes a proximate end spaced from the gas generator so as to define a gas chamber therebetween. The piston further includes a distal end facing the plurality of balls. Portions of the proximate end and the distal end are indented inward to form concave depressions at each end.

The concave depressions include flexible rims that act as pressure-activated seals. More specifically, the flexible rim at the proximate end is configured to expand circumferentially outward in response to forces exerted by the pressurized gas from the gas generator, and the flexible rim at the distal end is configured to expand circumferentially outward due to the application of backpressure from the plurality of balls. The expansion of the flexible rims at the proximate and distal ends create a tight seal between the piston and an inner peripheral wall of the tube, thereby reducing gas leakage beyond the distal end of the piston.

Further objects, features, and advantages of the invention will become apparent to those skilled in the art to which the present invention relates from consideration of the following description and the appended claims, taken in conjunction with the accompanied drawings.

### BRIEF DESCRIPTION OF THE DRAWINGS

The drawings described herein are for illustration purposes only and are not intended to limit the scope of the present disclosure in any way.

FIG. 1 is a perspective view of a vehicle seat and a seat belt assembly coupled with each other;

FIG. 2 is an isometric view of the seat belt assembly of FIG. 1;

FIG. 3 an isometric view of a retractor assembly shown in FIG. 2;

FIG. 4 is a side elevational view of a pretensioner assembly in accordance with the present invention with portions cut away;

FIGS. 5A and 5B are enlarged partial side views of a section of the pretensioner assembly of FIG. 4;

FIGS. 6A and 6B are enlarged side views of the pretensioner assembly showing operation of the pretensioner assembly;

FIGS. 7A and 7B are perspective views of a piston according to alternative embodiments the present invention; and

FIG. 8 is an isometric view of a piston according to one aspect of the present invention.

It should be understood that throughout the drawings, corresponding reference numerals indicate like or corresponding parts and features.

### DETAILED DESCRIPTION OF THE INVENTION

The following description is merely exemplary in nature and is not intended to limit the present disclosure or its application or uses.

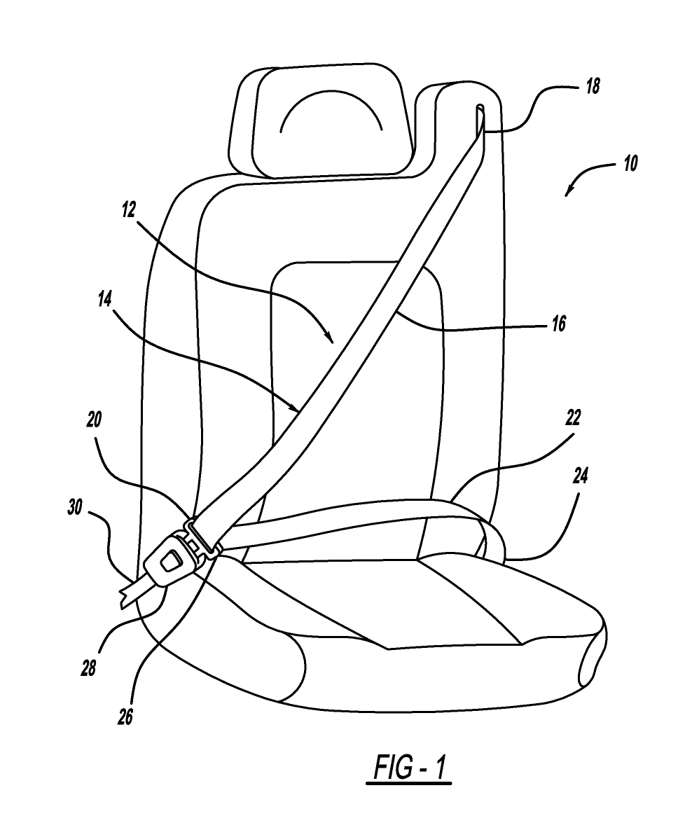

Referring now to the drawings, FIG. 1 shows a vehicle seat 10 and a seat belt assembly 12. The seat belt assembly 12 includes a seat belt webbing 14 having a shoulder belt portion 16 extending from an upper anchorage 18 to a buckle loop 20 and a lap belt portion 22 extending from the buckle loop 20 to an anchor point 24. A buckle latch plate 26 is able to be inserted into a seat belt buckle 28 to lock and unlock the seat belt assembly 12. A seat belt buckle cable 30, either directly or in cooperation with other components, secures the seat belt buckle 28 to a portion of the vehicle frame.

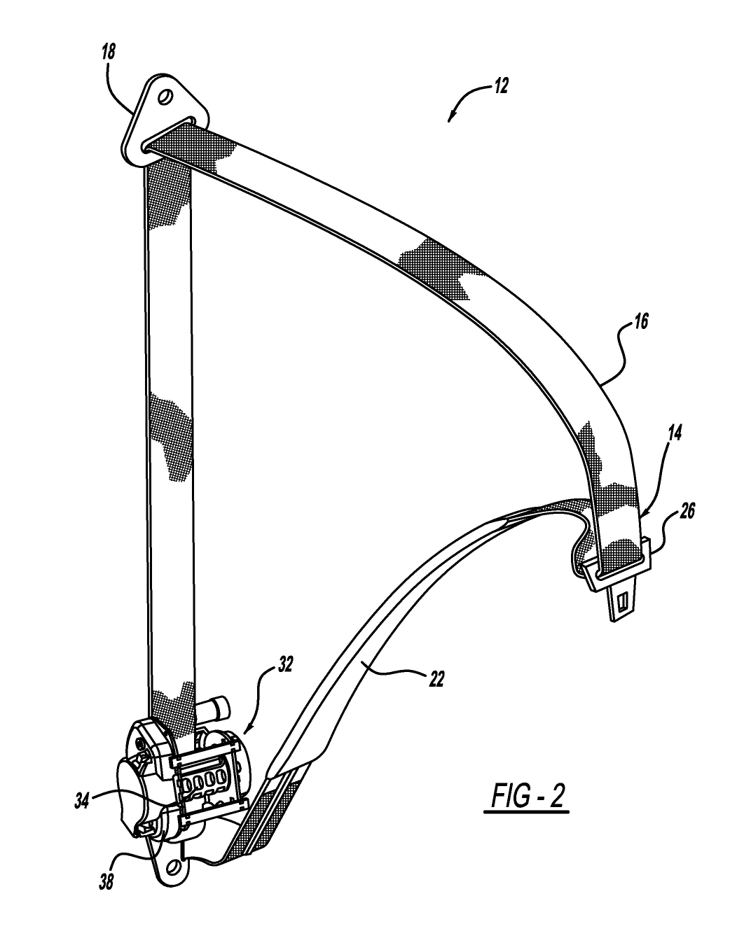

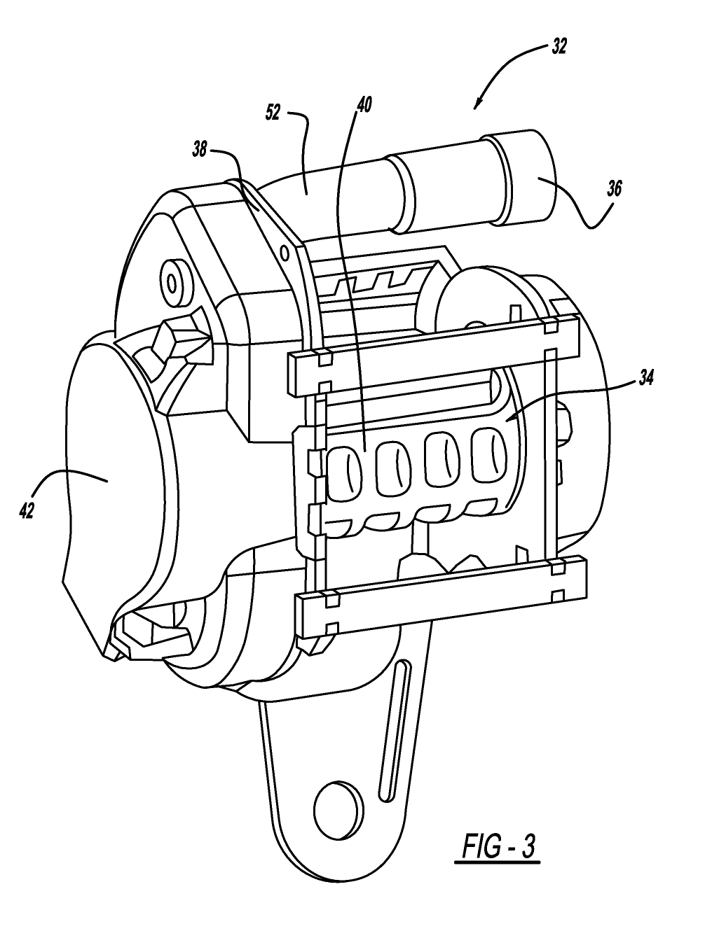

The seat belt webbing 14 is able to pay-out from a retractor 32 assembly (shown in FIGS. 2 and 3), which is located within the vehicle seat 10 (in an integrated structural seat design) or is coupled structurally to the vehicle body, so that the effective length of the seat belt webbing 14 is adjustable. When the buckle latch plate 26 has been fastened to the seat belt buckle 28, the seat belt assembly 12 defines a three-point contact between the upper anchorage 18, the buckle latch plate 26, and the anchor point 24. Any other suitable configurations, such as alternative locations for the retractor assembly 32, the buckle latch plate 26, and the anchor point 24, may be used with the present invention.

Now with reference to FIG. 2, an isometric view the seat belt assembly 12 of the present invention is illustrated disassociated from the motor vehicle and showing a spool retractor assembly 32. The retractor assembly 32 includes a spool assembly 34 and a gas generator 36 mounted to a common frame 38. The spool assembly 34 is connected with and stows the webbing 14 of the shoulder belt portion 16, whereas the end of the lap belt portion 22 of the webbing 14 is fixedly engaged with the anchorage point, for example, the frame 38 or another portion of the motor vehicle such as the seat 10.

As best shown in FIG. 3, the spool assembly 34 includes a belt spool 40 which engages the shoulder belt portion 16 of the webbing 14 and rotates to wind-up or pay-out the belt webbing 14. A torsional “clock” or “motor” type spring is carried within a spring end cap 42 and rotationally biases the spool 40 to retract the webbing 14. The spool assembly 34 may further incorporate other spool control mechanisms which are known in accordance with the prior art, including pretensioners, inertia and webbing sensitive locking devices, or other belt control devices. “Spool control systems” referred to in this specification may include any system which controls the rotational movement of a webbing spool, thus controlling the extraction and retraction of seat belt webbing. Spool locking devices typically incorporate an inertia sensitive element, such as a rolling ball or pendulum, and cause a sprocket of the spool to be engaged to prevent further withdrawing of webbing from the spool 40. Webbing sensitive locking devices sense rapid pay-out of webbing to lock the retractor. Various electronic sensing mechanisms which detect the withdrawal of webbing and/or the connection of the tongue 26 to the buckle 28 may also be incorporated into the retractor assembly 32.

During normal operation of the vehicle, the retractor assembly 32 allows pay-out of seat belt webbing 14 to give the occupant a certain amount of freedom of movement. However, if an impact or a potential impact situation is detected, the retractor assembly 32 is locked to prevent pay-out and to secure the occupant in the seat 10. For example, if the vehicle decelerates at a predetermined rate or if the brakes are actuated with a predetermined force, then the retractor assembly 32 is locked. Due in part to the free pay-out of the seat belt webbing 14, the seat belt assembly 12 often develops slack during normal use.

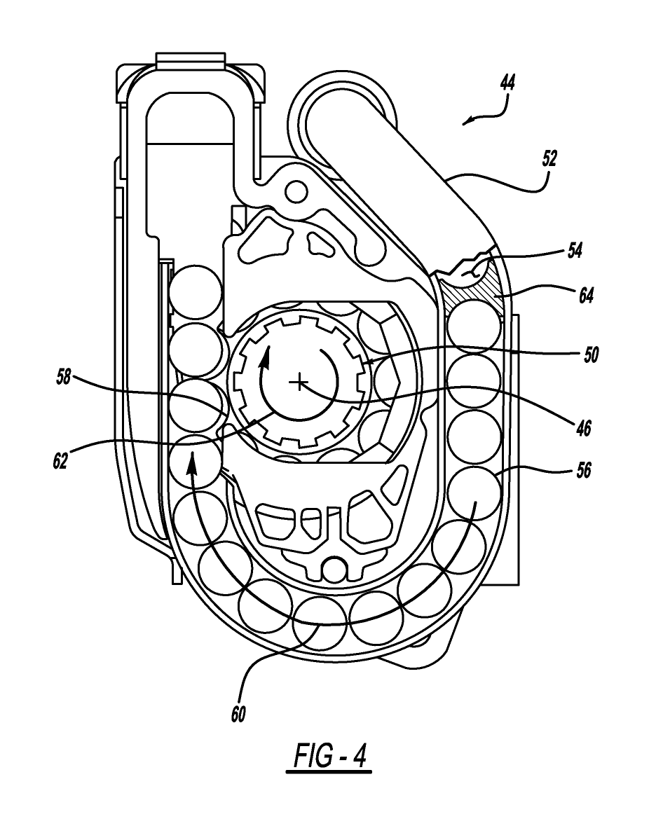

The retractor assembly 32 further incorporates a pretensioner system 44 (shown in FIG. 4) operatively connected to the spool assembly 34 and operable to rotate the spool 40 for pretensioning. As known to those of skill in the art, a retractor pretensioner winds seat belt webbing into a more taught condition against the occupant at the initial stages of a detected vehicle impact. This is provided to reduce forward motion or excursion of the occupant in response to the deceleration forces of a vehicle impact or rollover.

The pretensioner system 44 includes a pretensioner tube 52 in communication with the gas generator 36. The gas generator 36 is used to provide expanding gas in response to a firing signal. As is known in the art, for example, the vehicle includes a sensor sending a signal indicative of an emergency event such as an impact event, crash, or rollover. The vehicle sensor may be a specific impact sensor, or may be a traditional vehicle sensor (e.g. a longitudinal or lateral acceleration sensor) or otherwise part of a control system having a suite of multiple sensors. Any other impact sensor that is or will be known to those skilled in the art may also be readily employed in conjunction with the seat belt assembly 12 of present invention. An electronic control unit such as a central processing unit (CPU) or other controller receives a signal and controls the seat belt assembly 12 to respond by tightening the seatbelt of the vehicle (e.g. via activation of a pretensioner).

FIG. 4 provides a cut-away illustration of the pretensioner tube 52 acting on the lap belt spool assembly 34. As shown in the cut-away illustration, the pretensioner tube 52 includes a plurality of ball bearings or internally stored balls 56 composed of any suitable material such as a metal (e.g., aluminum or steel) or polymer (e.g., polyester and/or rubber). The tube 52 further includes a piston 64 having a cylindrical outer surface, as best shown in FIG. 8. The piston 64 is slidably disposed within the tube 52 and is operable to drive the balls 56 along an actuating path 60. As will be understood by those of skill in the art, the piston 64 may be press-fitted or otherwise fitted inside the tube 52.

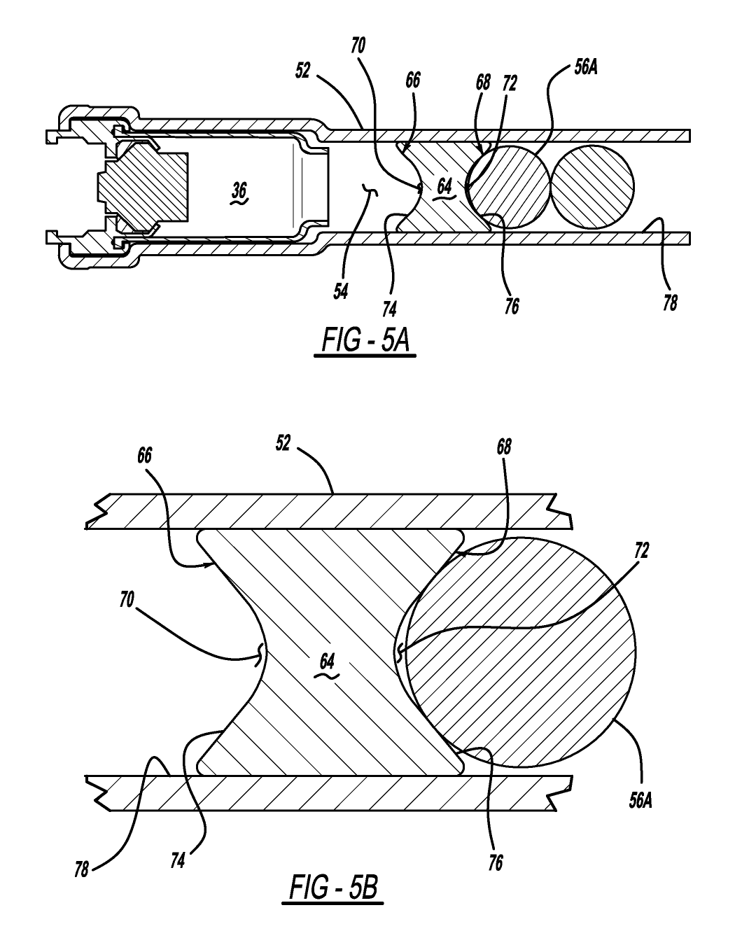

Referring now to FIGS. 5A and 5B, the piston 64 forms a proximal end 66 spaced from the gas generator 36 so as to define a gas chamber 54 therebetween. The piston 64 further forms a distal end 68 adjacent to the lead ball 56A. The proximal end 66 and the distal end 68 are each indented inward so as to define semi-spherical recesses or concave depressions 70 and 72, forming rims 74 and 76 at opposite ends of the piston 64.

As will be discussed in greater detail below, the piston 64 defines a generally elastic structure, and may be composed of various materials known in the art, such as any suitable plastic or polymer (e.g., polyester, rubber, thermoplastic, or other elastic or deformable material). Moreover, the piston 64 may be die cast, forged, or molded from metal, plastic, or other suitable material. In one aspect of the present invention, the piston 64 may be formed using a two-cavity injection molding process.

In operation, the gas generator 36 produces expanding gas that pressurizes the gas chamber 54, thereby enabling the piston 64 to forcibly drive the balls 56 along the actuation path 60. As the balls 56 are driven through tube 52, they engage a spool sprocket assembly 50 that is rotatable about an axis 46. The spool sprocket assembly 50 forms bearing seats 58 that are semi-spherical depressions with an appropriate shape and size to receive the balls 56. Engagement of the balls 56 with the spool sprocket assembly 50 as they are driven by expanding gas in the direction of arrow 60 causes the spool 40 to rotate, which in turn provides pretensioning. Of course, it should be understood that while the pretensioner system 44 employs balls 56 for rotating the spool 40, the pretensioner system 44 may use any suitable driving element known in the art.

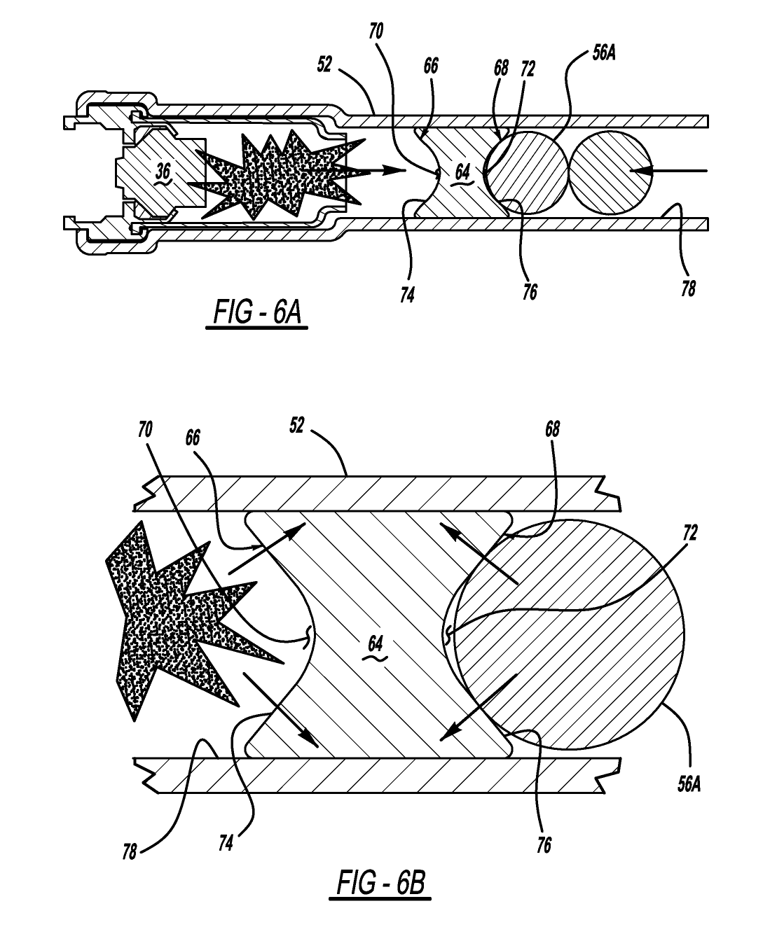

Referring now to FIGS. 6A and 6B, it can further be seen that activation of the gas generator 36 enables the piston 64 to resist gas leakage. As previously mentioned, the piston 64 is composed of a relatively elastic material. Therefore, pressurized gas within the gas chamber 54 causes the proximal end 66 of the piston 64 to expand, which helps prevent gas from escaping past the piston 64. More specifically, the concave depression 70 at the proximal end 66 forms a flexible rim 74 that expands circumferentially outward in response to pressurized gas. Hence, the rim 74 at the proximal end 66 functions as a pressure-activated gas seal that enables the piston 64 to utilize the pressure of the trapped gas in order to force the balls 56 forward.

In addition, backpressure generated from the balls 56 causes the flexible rim 76 formed by the concave depression 72 at the distal end 68 of the piston 64 to expand circumferentially outward. The expansion of the rims 74 and 76 at the proximal and distal ends 66 and 68 of the piston 64 provide a tightened seal between the outer cylindrical surface of the piston 64 and the inner peripheral wall 78 of the pretensioner tube 52. Accordingly, the piston 64 of the present invention is operable to retain a high seal pressure as well as maintain residual gas pressure within the tube 52.

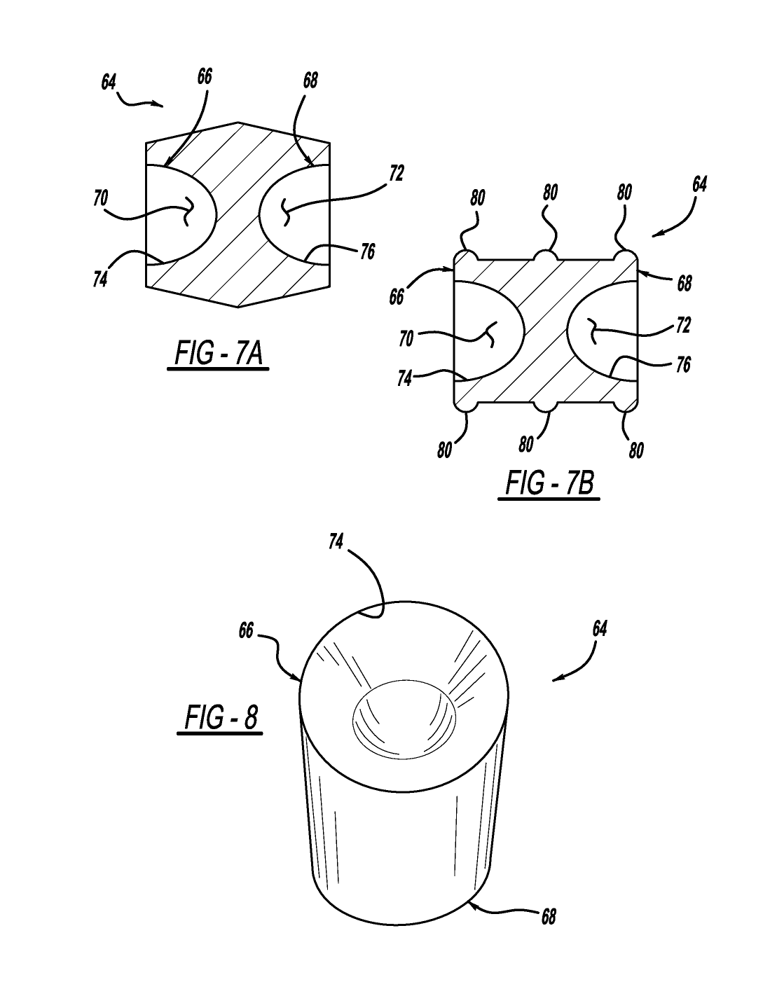

It should be understood that while the piston 64 includes a generally cylindrical exterior, the piston 64 may include a variety of shapes. For instance, the piston 64 may be shaped so that contact between certain areas of the piston 64 and the inner peripheral wall 78 of the tube is maximized upon expansion of the piston. As shown in FIG. 7A, for example, the piston 64 may include an outer surface having a diameter that gradually decreases from the center towards the proximal and distal ends 66 and 68. The increased center diameter helps provide additional sealing between the central exterior surface of the piston 64 and the inner peripheral wall 78 of the pretensioner tube 52.

Alternatively, the piston 64 may include a generally flat outer surface having discrete seals 80 formed at specific areas such as the center and outer ends of the piston 64, as shown in FIG. 7B. Moreover, the piston 64 may be shaped such that the concave depression 72 at the distal end 68 of the piston 64 has a diameter that is smaller than the diameter of the lead ball 56A, as shown in FIGS. 5B and 6B. Accordingly, the lead ball 56A may apply greater pressure at certain points of the concave depression 72 that enhance the outward expansion of the rim 76 formed at the distal end 68.

In addition, while the concave depressions 70 and 72 are shown in the drawings as having a semi-spherical shape, it is to be understood that the concave depressions 70 and 72 may be of any suitable shape that enables the rims 74 and 76 to expand outward and form seals with the piston 64. Furthermore, since both rims 74 and 76 are operable to form seals, the piston 64 may be shaped such that only one of the rims 74 or 76 is provided. That is, either the proximate end 66 or the distal end 68 may be indented inward to form a single concave depression 70 or 72 having a rim 74 or 76.

As a person skilled in the art will readily appreciate, the above description is meant as an illustration of the implementation of the principles of this invention. This description is not intended to limit the scope or application of this invention in that the invention is susceptible to modification, variation, and change, without departing from the spirit of this invention as defined in the following claims.

1. A pretensioner assembly for retracting a seatbelt webbing of a motor vehicle, the pretensioner assembly comprising:
a tube;
a gas generator for producing gas conducted within the tube; and
a piston disposed within the tube and operable to drive a driving element upon receiving pressurized gas discharged from the gas generator, the piston having a proximate end facing the gas generator and a distal end facing the driving element, the proximate end and the distal end each having a portion indented inward to respectively define a proximate concave depression and a distal concave depression, the proximate concave depression forming a proximate flexible rim that expands circumferentially outward when pressurized gas from the gas generator enters the proximate concave depression, the distal concave depression forming a distal flexible rim that expands circumferentially outward when backpressure from the driving element is applied to the distal concave depression;
wherein expansion of the proximate and distal flexible rims form seals around surfaces of the piston that are in contact with an inner peripheral wall of the tube.

2. The pretensioner assembly of claim 1, wherein expansion of the proximate flexible rim forms a proximate seal for preventing gas from leaking beyond the proximate end of the piston.

3. The pretensioner assembly of claim 1, wherein expansion of the distal flexible rim forms a distal seal for preventing gas from leaking beyond the distal end of the piston.

4. The pretensioner assembly of claim 1, wherein the piston includes a generally cylindrical outer surface.

5. The pretensioner assembly of claim 4, wherein the piston includes an increased central diameter portion that expands circumferentially outward in response to pressure acting on at least one of the proximate or distal concave depressions, and
wherein expansion of the increased central diameter portion creates a central seal with the inner peripheral wall of the tube.

6. The pretensioner assembly of claim 4, wherein at least one of the proximate or distal concave depressions define a semi-spherical shaped recess.

7. The pretensioner assembly of claim 1, wherein the driving element includes a plurality of balls operable to rotate a spool for pretensioning the seatbelt webbing, the plurality of balls having a lead ball that is directly adjacent to the distal end.

8. The pretensioner assembly of claim 7, wherein the distal concave depression includes a diameter that is smaller than the diameter of the lead ball.

9. The pretensioner assembly of claim 1, wherein the piston is composed of an elastic polymer.

10. The pretensioner assembly of claim 1, wherein the piston is molded by way of a two-cavity injection molding process.

11. A pretensioner assembly for retracting a seatbelt webbing of a motor vehicle, the pretensioner assembly comprising:
a tube;
a gas generator for producing gas conducted within the tube; and
an elastic piston disposed within the tube and operable to drive a plurality of balls upon receiving pressurized gas discharged from the gas generator, the elastic piston having a proximate end facing the gas generator and a distal end facing the plurality of balls, the proximate end and the distal end each having a portion indented inward to respectively define a proximate concave depression and a distal concave depression, the proximate concave depression forming a proximate flexible rim that expands circumferentially outward when pressurized gas from the gas generator enters the proximate concave depression, the distal concave depression forming a distal flexible rim that expands circumferentially outward when backpressure from the plurality of balls is applied to the distal concave depression;
wherein expansion of the proximate flexible rim forms a proximate seal around a proximate outer surface of the elastic piston that is in contact with an inner peripheral wall of the tube; and
wherein expansion of the distal flexible rim forms a distal seal around a distal outer surface of the elastic piston that is in contact with the inner peripheral wall of the tube.

12. The pretensioner assembly of claim 11, wherein the elastic piston includes a generally cylindrical outer surface.

13. The pretensioner assembly of claim 12, wherein the elastic piston includes an increased central diameter portion that expands circumferentially outward in response to pressure acting on at least one of the proximate or distal concave depressions, and
wherein expansion of the increased central diameter portion creates a central seal with the inner peripheral wall of the tube.

14. The pretensioner assembly of claim 12, wherein at least one of the proximate or distal concave depressions define a semi-spherical shaped recess.

15. The pretensioner assembly of claim 11, wherein the distal concave depression includes a diameter that is smaller than the diameter of a lead ball selected from the plurality of balls, the lead ball being directly adjacent to the distal end of the elastic piston.

16. A pretensioner assembly for retracting a seatbelt webbing of a motor vehicle, the pretensioner assembly comprising:
a tube;
a gas generator for producing gas conducted within the tube; and
a piston disposed within the tube and operable to drive a driving element upon receiving pressurized gas discharged from the gas generator, the piston having a proximate end facing the gas generator and a distal end facing the driving element, at least one of the proximate end or the distal end defining a concave depression, the concave depression having a rim that expands to form a seal in response to pressure acting on the concave depression, the seal being formed around surfaces of the piston that are in contact with an inner peripheral wall of the tube.

17. The pretensioner assembly of claim 16 wherein a portion of the proximate end is indented inward so as to define the concave depression.

18. The pretensioner assembly of claim 17 wherein the concave depression forms the rim, the rim being a flexible rim that expands circumferentially outward in response to pressurized gas entering the concave depression, and
wherein expansion of the flexible rim forms a proximate seal around a proximate outer surface of the piston that is in contact with the inner peripheral wall of the tube.

19. The pretensioner assembly of claim 16 wherein a portion of the distal end is indented inward so as to define the concave depression.

20. The pretensioner assembly of claim 19 wherein the concave depression forms the rim, the rim being a flexible rim that expands circumferentially outward in response to the driving element applying backpressure to the concave depression, and
wherein expansion of the flexible rim forms a distal seal around a distal outer surface of the piston that is in contact with the inner peripheral wall of the tube.
